(19) United States
(12) Patent Application Publication
(10) Pub. No.: US 2026/0112667 A1
(43) Pub. Date: Apr. 23, 2026

(54) FUEL CELL SYSTEM

(71) Applicant: AISAN KOGYO KABUSHIKI KAISHA, Obu-shi (JP)

(72) Inventor: Daisaku ASANUMA, Gamagori-shi (JP)

(73) Assignee: AISAN KOGYO KABUSHIKI KAISHA, Obu-shi (JP)

(21) Appl. No.: 19/348,180

(22) Filed: Oct. 2, 2025

(30) Foreign Application Priority Data
Oct. 21, 2024 (JP) 2024-184787

(51) Int. Cl. H01M 8/04791; H01M 8/04082; H01M 8/0438; H01M 8/2457

(52) U.S. Cl. CPC H01M 8/04805; H01M 8/04216; H01M 8/04388; H01M 8/2457

(57) ABSTRACT

A fuel cell system includes an FC stack, a hydrogen gas supply passage, a hydrogen off-gas circulation passage, an ejector, an exhaust-drain valve, a pressure sensor for hydrogen gas, and a controller. The controller variably controls a time ratio between an opening time and a closing time of the exhaust-drain valve per one control cycle, and controls the number of opening-closing operations of the exhaust-drain valve per unit time by keeping the opening time constant and controlling the closing time variably. The controller controls the number of opening-closing operations of the exhaust-drain valve according to a pressure measured value of the pressure sensor in order to adjust the concentration of hydrogen gas in hydrogen off-gas caused to circulate to the hydrogen gas supply passage via the hydrogen off-gas circulation passage.

### CROSS-REFERENCE TO RELATED APPLICATIONS

This application is based upon and claims the benefit of priority to Japanese Patent Application No. 2024-184787 filed on October 21, 2024, the entire contents of which are incorporated herein by reference.

### BACKGROUND

### TECHNICAL FIELD

The disclosure relates to a fuel cell system provided with a fuel cell that generates electricity, or electric power, by receiving supply of fuel gas and oxidant gas.

### RELATED ART

Conventionally, as this type of technique, for example, a fuel cell system described in Japanese unexamined patent application publication No. 2022-121309 (JP2022-121309A) has been known. This system includes a fuel cell, a fuel gas supply passage for supplying fuel gas to the fuel cell, an injector provided in the fuel gas supply passage, an ejector provided in the fuel gas supply passage between the injector and the fuel cell, and a fuel off-gas circulation passage for recirculating fuel off-gas discharged from the fuel cell to the ejector. This ejector is configured to generate negative pressure by the fuel gas injected from the injector, suck the fuel off-gas from the fuel off-gas circulation passage using the negative pressure, and discharge a mixture of the fuel off-gas and the fuel gas to the fuel cell.

### SUMMARY

### TECHNICAL PROBLEMS

However, in the fuel cell system described in JP2022-121309A, the pressure of the fuel gas supplied to the injector may decrease. In this system, as the amount of fuel in a fuel tank runs low, the pressure of fuel gas supplied to the injector drops, resulting in a decrease in the flow velocity of fuel gas injected from the injector to the ejector. Thus, the negative pressure generated in the ejector is low and the amount of fuel off-gas sucked into the ejector is reduced, so that the circulation efficiency of the fuel off-gas to the ejector decreases. This may lead to a decrease in the concentration of fuel gas supplied to the fuel cell, which may degrade the power generation performance of the fuel cell.

Meanwhile, when hydrogen is used as fuel, a hydrogen alloy canister with internally-contained hydrogen alloy that can absorb hydrogen may be used instead of the fuel tank. In this case, the pressure of hydrogen gas released from the hydrogen alloy canister greatly varies depending on the temperature of the canister. In particular, when the temperature of the canister decreases, the pressure of hydrogen gas supplied to the injector drops. This may cause the same problem as above.

The disclosure has been made to address the above problems and has a purpose to provide a fuel cell system capable of adjusting the concentration of fuel gas to be supplied from an ejector to a fuel cell even when the pressure of the fuel gas supplied to the ejector is low, thereby suppressing degradation of the power generation performance of the fuel cell.

### MEANS OF SOLVING THE PROBLEMS

To achieve the above-mentioned purpose, one aspect of the disclosure provides a fuel cell system provided with a fuel cell that generates electric power by receiving supply of fuel gas and oxidant gas, the fuel cell system comprising: a fuel gas supply passage for supplying the fuel gas to the fuel cell; a fuel off-gas exhaust passage for exhausting fuel off-gas discharged from the fuel cell to an outside of the fuel cell system; a fuel off-gas circulation passage for circulating at least a part of the fuel off-gas from the fuel off-gas exhaust passage to the fuel gas supply passage; a fuel gas supply unit placed in the fuel gas supply passage and configured to supply the fuel gas; an ejector placed downstream of the fuel gas supply unit in the fuel gas supply passage and configured to discharge a mixture of the fuel gas supplied from the fuel gas supply unit and the fuel off-gas circulating through the fuel off-gas circulation passage; an exhaust-drain valve placed in the fuel off-gas exhaust passage and configured to exhaust the fuel off-gas to the outside; a pressure sensor placed in the fuel gas supply passage and used to measure a pressure of the fuel gas upstream of the ejector; and a controller configured to control the exhaust-drain valve. The controller variably controls a time ratio between an opening time and a closing time of the exhaust-drain valve per one control cycle, and controls the number of opening-closing operations of the exhaust-drain valve per unit time by keeping the opening time constant and controlling the closing time variably. The controller controls the number of opening-closing operations of the exhaust-drain valve according to a pressure measured value of the pressure sensor in order to adjust a concentration of the fuel gas in the fuel off-gas caused to circulate to the fuel gas supply passage via the fuel off-gas circulation passage.

According to the above-described configuration, the controller variably controls the time ratio between the opening time and the closing time of the exhaust-drain valve per one control cycle, and controls the number of opening-closing operations of the exhaust-drain valve per unit time by keeping the opening time constant and controlling the closing time variably. Keeping the opening time constant is to suppress the exhaust-drain valve from opening for an excessive long period of time. Here, the longer the closing time, the fewer the number of opening-closing operations of the exhaust-drain valve per unit time, so that the total opening time of the exhaust-drain valve per unit time is short. This reduces the circulation flow rate of fuel off-gas circulating to the fuel gas supply passage via the fuel off-gas circulation passage. In contrast, the shorter the closing time, the greater the number of opening-closing operations per unit time, so that the total opening time of the exhaust-drain valve per unit time is long. This allows gases (nitrogen, water, etc.) produced by power generation of the fuel cell to be frequently discharged, thereby increasing the concentration of fuel gas in the fuel off-gas circulating to the fuel gas supply passage via the fuel off-gas circulation passage. Furthermore, the controller controls the number of opening-closing operations of the exhaust-drain valve according to the pressure measured value of fuel gas upstream of the ejector. Accordingly, the number of opening-closing operations is adjusted in accordance with the pressure of the fuel gas, thereby adjusting the concentration of the fuel gas in the fuel off-gas to be mixed with fuel gas in the ejector. Therefore, even if the pressure of fuel gas supplied to the ejector is low, it is possible to adjust the concentration of fuel gas to be supplied from the ejector to the fuel cell, and thus suppress degradation of the power generation performance of the fuel cell.

### BRIEF DESCRIPTION OF THE DRAWINGS

FIG. 1 is a schematic diagram showing a fuel cell system in an embodiment;

FIG. 2 is a time chart showing opening-closing operations of an exhaust-drain valve in the embodiment;

FIG. 3 is a time chart showing the opening-closing operations of the exhaust-drain valve in the embodiment;

FIG. 4 is a graph showing a relationship between hydrogen concentration and hydrogen pressure of hydrogen absorbed in and released from a hydrogen alloy canister and temperature of the canister;

FIG. 5 is a flowchart showing contents of a hydrogen off-gas circulation amount control in the embodiment; and

FIG. 6 is a closing time map showing a relationship between inlet gas pressure and closing time for a FC current in the embodiment.

### DETAILED DESCRIPTION OF THE EXEMPLARY EMBODIMENTS

A detailed description of an embodiment of a fuel cell system to be mounted in an electric vehicle will now be given referring to the accompanying drawings.

### CONFIGURATION OF FUEL CELL SYSTEM

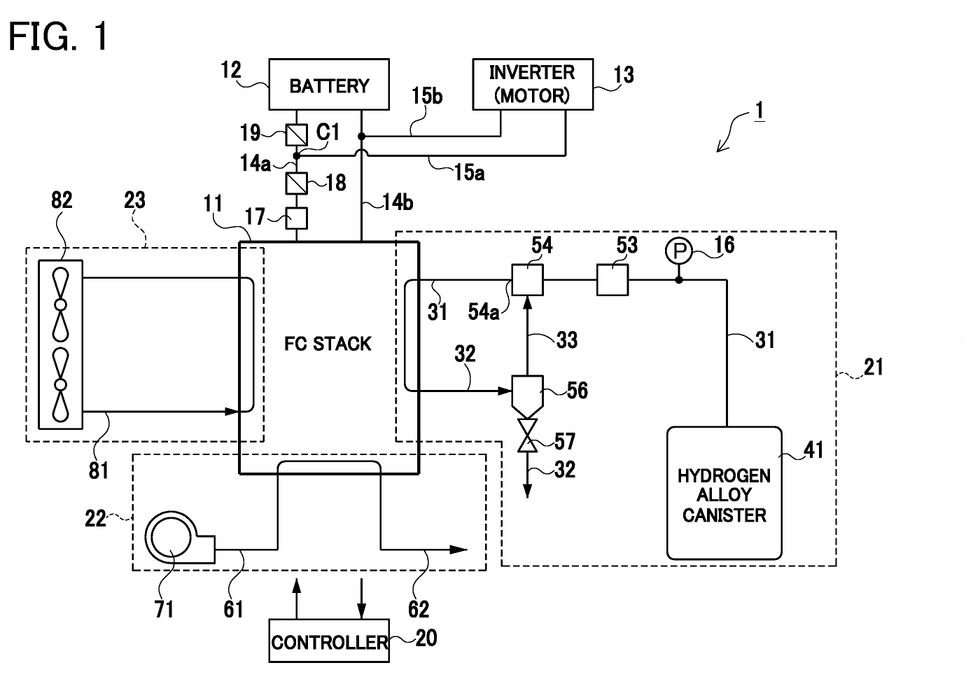

FIG. 1 is a schematic configuration showing a fuel cell system 1 in the present embodiment. As shown in FIG. 1, this fuel cell system 1 includes an FC stack 11, a battery 12, an inverter 13 (or a motor).

The fuel cell system 1 in the embodiment, in which the above-mentioned devices 11 to 13 are connected in parallel to each other, is configured as a simple DC-DC converter-less system having no DC-DC converter. Here, a DC-DC converter is a device that converts DC (direct current) voltage into another DC (direct current) voltage, and serves to convert voltage used in the system while maintaining it as direct current.

This fuel cell system 1 further includes a hydrogen system 21 and an air system 22. In the present embodiment, fuel gas is hydrogen gas, and oxidant gas is air (atmospheric air). The FC stack 11 generates electric power by receiving the hydrogen gas supplied from the hydrogen system 21 and the air supplied from the air system 22. The FC stack 11 is one example of a fuel cell of the disclosure. The electric power generated in the FC stack 11 is supplied to the battery 12 and the inverter 13.

The battery 12 is connected to the FC stack 11 via first wires 14a and 14b. The electric power generated in the FC stack 11 is charged to the battery 12 via the first wires 14a and 14b. The battery 12 is connected to the inverter 13 via the first wires 14a and 14b and second wires 15a and 15b. The second wire 15a is connected to the first wire 14a. The second wire 15b is connected to the first wire 14b. The electric power charged to the battery 12 is supplied to the inverter 13 via the first wires 14a and 14b and the second wires 15a and 15b. The inverter 13 is driven by the electric power supplied from the FC stack 11 and/or the battery 12 via the first wires 14a and 14b and the second wires 15a and 15b. In the first wire 14a nearby an output port of the FC stack 11, an ammeter 17 is provided to measure an FC current IFC, which is an output current of the FC stack 11.

In the first wire 14a between the FC stack 11 and the inverter 13, an FC relay 18 is provided to switch between connection and disconnection of the first wire 14a. In the first wire 14a between the battery 12 and the inverter 13, a battery relay 19 is provided to switch between connection and disconnection of the first wire 14a. The FC relay 18 is placed in the first wire 14a between the ammeter 17 and the joint C1 at which the first wire 14a and the second wire 15a are connected to each other. The battery relay 19 is placed in the first wire 14a between the battery 12 and the joint C1 at which the first wire 14a and the second wire 15a are connected to each other. Here, each of the relays 18 and 19 is a component that receives electric signals from an external device and turns on/off or switches an electric circuit, and has a well-known configuration.

The hydrogen system 21 is provided on an anode side of the FC stack 11. This hydrogen system 21 includes a hydrogen gas supply passage 31, an exhaust-drain passage 32, a hydrogen off-gas circulation passage 33, and a hydrogen alloy canister 41.

The hydrogen gas supply passage 31 is a passage for supplying hydrogen from the hydrogen alloy canister 41, in which hydrogen is absorbed, to the FC stack 11. The hydrogen gas supply passage 31 is one example of a fuel gas supply passage of the disclosure. The hydrogen alloy canister 41 contains hydrogen alloy that can absorb and release hydrogen. The hydrogen alloy canister 41 is one example of a fuel gas supply unit of the disclosure. The exhaust-drain passage 32 is a passage for exhausting hydrogen off-gas and water, which are discharged from the FC stack 11. The exhaust-drain passage 32 is one example of a fuel off-gas exhaust passage of the disclosure.

The hydrogen system 21 includes an injector 53 and an ejector 54, which are arranged in the hydrogen gas supply passage 31 downstream from the hydrogen alloy canister 41.

The hydrogen off-gas circulation passage 33 is a passage that connects the exhaust-drain passage 32 (specifically, including a gas-liquid separator 56) and the ejector 54 and that serves to recirculate hydrogen off-gas to the hydrogen gas supply passage 31 via the ejector 54. The hydrogen off-gas circulation passage 33 is one example of a fuel off-gas circulation passage of the disclosure.

The injector 53 is a device that injects the hydrogen gas released from the hydrogen alloy canister 41 toward the ejector 54. The injector 53 is constituted of, e.g., an electromagnetic valve. The injector 53 is configured to adjust the discharge pressure of hydrogen gas (i.e., hydrogen gas pressure) by, for example, moving a needle valve to adjust the opening degree of an injection port. The injector 53 is one example of the fuel gas supply unit of the disclosure.

The ejector 54 is configured to generate a negative pressure by hydrogen gas injected from the injector53, suck the hydrogen off-gas flowing through the hydrogen off-gas circulation passage 33 using the negative pressure, and discharge a mixture of the hydrogen off-gas and a hydrogen gas from an outlet 54a toward the FC stack 11.

The hydrogen system 21 is further includes the gas-liquid separator 56 and an exhaust-drain valve 57 arranged in this order from the FC stack 11 side in the exhaust-drain passage 32. The gas-liquid separator 56 is an electric device that separates water from hydrogen off-gas. The exhaust-drain valve 57 is a valve that switches between exhausting and shutting off the hydrogen off-gas and water from the gas-liquid separator 56. This valve 57 is constituted of, for example, an electromagnetic valve. In the present embodiment, the exhaust-drain valve 57 is configured to be able to change the number of opening-closing operations of a valve body with respect to a valve seat per unit time by controlling an amount of current supplied to the valve 57.

In the hydrogen system 21, a pressure sensor 16 is provided in the hydrogen gas supply passage 31 between the hydrogen alloy canister 41 and the injector 53. This pressure sensor 16 is a sensor for measuring the pressure PH1 of hydrogen gas to be supplied to the injector 53, i.e., inlet gas pressure.

On the other hand, the air system 22 is provided on the cathode side of the FC stack 11. This air system 22 includes an air supply passage 61 and an air exhaust passage 62. The air supply passage 61 is a passage for supplying air from the outside of the fuel cell system 1 to the FC stack 11. The air exhaust passage 62 is a passage for exhausting the air discharged from the FC stack 11, i.e., air off-gas.

The air system 22 further includes an air compressor 71 in the air supply passage 61. The air compressor 71 is an electric device that supplies air to the FC stack 11. In the present embodiment, any device, such as an air valve, is not provided in the air supply passage 61 between the air compressor 71 and the FC stack 11 and in the air exhaust passage 62. In other words, in the present embodiment, air is supplied from the air compressor 71 directly to the FC stack 11 and air off-gas is exhausted directly from the FC stack 11 to the outside.

In addition, the fuel cell system 1 in the embodiment further includes a cooling system 23 for cooling the FC stack 11. This cooling system 23 includes an air passage 81 that circulates air and an electric cooling fan 82 for cooling the air flowing through the air passage 81. In the embodiment, specifically, the cooling system 23 and the air system 22 are separately provided and configured as a closed cathode system.

This fuel cell system 1 further includes a controller 20 for controlling the system 1. The controller 20 includes, for example, an arithmetic processing unit such as a CPU, a memory unit including a ROM that stores control programs and control data to be processed by the CPU, a RAM used as various work areas for control processing, and others, and an input/output interface unit. The controller 20 executes various controls of the fuel cell system 1 in accordance with the control program stored in the memory unit.

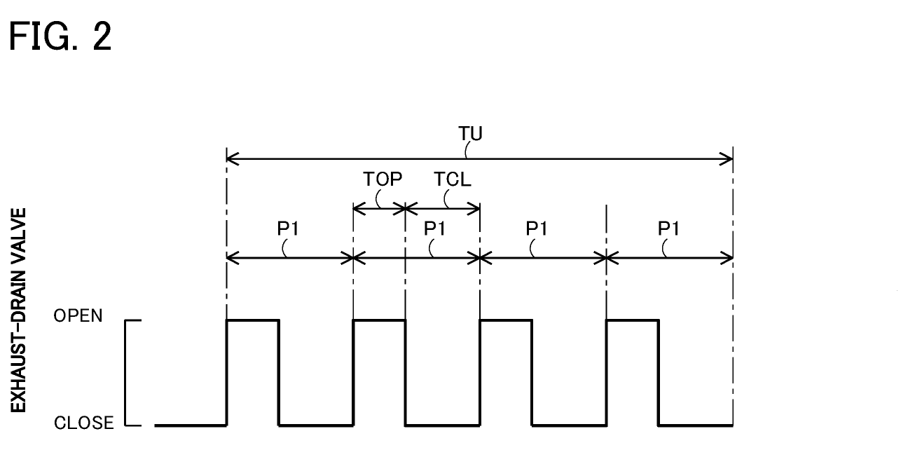

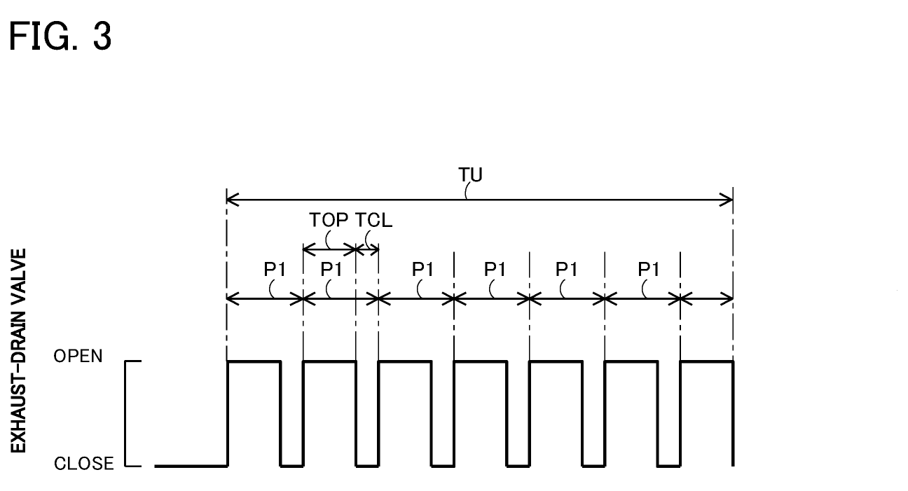

FIG. 2 and FIG. 3 are time charts showing the opening and closing operations of the exhaust-drain valve 57. In the present embodiment, as shown in FIG. 2 and FIG. 3, the controller 20 is configured to control the number of opening-closing operations of the exhaust-drain valve 57 per unit time TU by variously controlling a time ratio between an opening time TOP and a closing time TCL of the exhaust-drain valve 57 per one control cycle P1 (duty control) and further keeping the opening time TOP constant and controlling the closing time TCL variably. FIG. 2 shows that the closing time TCL is set long. FIG. 3 shows that the closing time TCL is set short. From FIG. 2 and FIG. 3, it is revealed that when the closing time TCL is set short, the number of opening-closing operations of the exhaust-drain valve 57 per unit time TU is greater than when the closing time TCL is set long, so that the total opening time per unit time TU is made longer.

### OPERATIONS OF FUEL CELL SYSTEM

In the fuel cell system 1 configured as above, the hydrogen gas supplied to the FC stack 11 through the hydrogen gas supply passage 31 is used for power generation in the FC stack 11 and then exhausted as hydrogen off-gas from the FC stack 11 to the outside of the fuel cell system 1 through the exhaust-drain passage 32, and also circulates to the hydrogen gas supply passage 31 via the hydrogen off-gas circulation passage 33 and the ejector 54. Furthermore, the air supplied to the FC stack 11 through the air supply passage 61 is used for power generation in the FC stack 11 and then exhausted as air off-gas from the FC stack 11 to the outside of the fuel cell system 1 through the air exhaust passage 62.

The electric power generated in the FC stack 11 is charged to the battery 12 and used to drive the inverter 13. The inverter 13 is also supplied with electric power from the battery 12.

The fuel cell system 1 in the embodiment is configured such that the voltage of the FC stack 11 (i.e., FC voltage) is electrically equal or nearly equal to the voltage of the battery 12 (i.e., battery voltage). Thus, the current IFC of the FC stack 11 (i.e., FC current) depends on the battery voltage. In other words, the electric power generated in the FC stack 11 is supplied to the battery 12 and the inverter 13 without converting the FC voltage. The FC current IFC is the current of electric power generated by the FC stack 11. The battery voltage is the voltage of the battery 12.

In this fuel cell system 1, since the FC voltage is equal to the battery voltage, the FC stack 11 performs “uncontrolled power generation” according to the battery voltage during power generation. In this fuel cell system 1, when the charge rate of the battery 12 increases, the hydrogen injection pressure of the injector 53 is controlled to a stop pressure and the air compressor 71 is stopped, causing the FC stack 11 to perform “low-current power generation” to decrease the FC voltage below the battery voltage and intermittently stop power generation of the FC stack 11. This can improve the fuel efficiency of the fuel cell system 1.

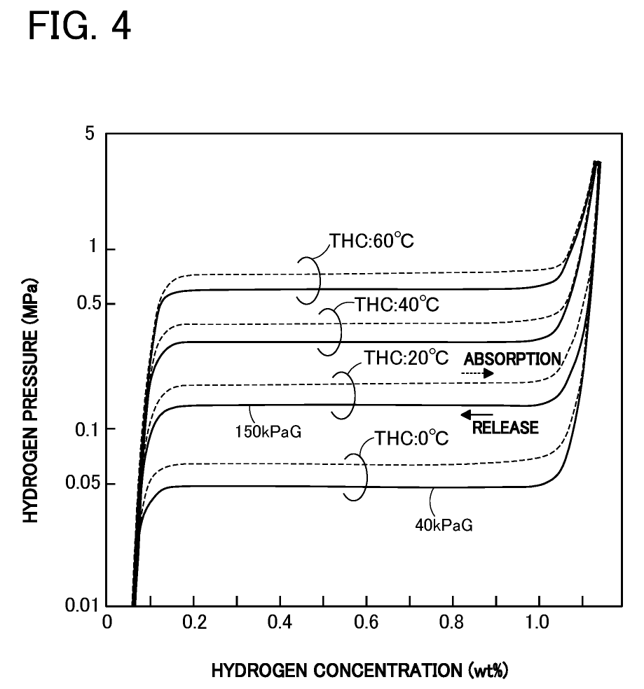

In the present embodiment, the hydrogen alloy canister 41 is used in the hydrogen system 21, and thus the pressure of hydrogen gas released from the hydrogen alloy canister 41 greatly varies depending on the temperature of this canister 41. FIG. 4 is a graph showing the relationship of “hydrogen concentration” and “hydrogen pressure” of hydrogen, which is absorbed into and released from the hydrogen alloy canister, and “canister temperature THC”. As shown in FIG. 4, it is revealed that the value of the hydrogen pressure corresponding to a certain hydrogen concentration is lower as the canister temperature THC is lower in the range of 0 to 60 (°C). In FIG. 4. for each canister temperature THC, the hydrogen pressure is higher during absorption than during release.

As seen in FIG. 4, in the present embodiment, when the canister temperature THC decreases, the pressure of hydrogen gas supplied to the injector 53 drops, the negative pressure generated in the ejector 54 becomes lower, and therefore the circulation efficiency of hydrogen off-gas to the ejector 54 decreases. Accordingly, the pressure of hydrogen off-gas mixed with hydrogen gas in the ejector 54 decreases, and the pressure of hydrogen gas to be supplied from the ejector 54 to the FC stack 11 decreases. Thus, the concentration of hydrogen gas supplied to the FC stack 11 does not increase, reducing the power generation efficiency of the FC stack 11. To address the above-mentioned problems, therefore, the controller 20 in the present embodiment executes the following control of the circulation amount of hydrogen off-gas flowing to the ejector 54. For this control, the controller 20 is configured to control the exhaust-drain valve 57 based on measured values of the pressure sensor 16 and the ammeter 17.

### HYDROGEN OFF-GAS CIRCULATION AMOUNT CONTROL

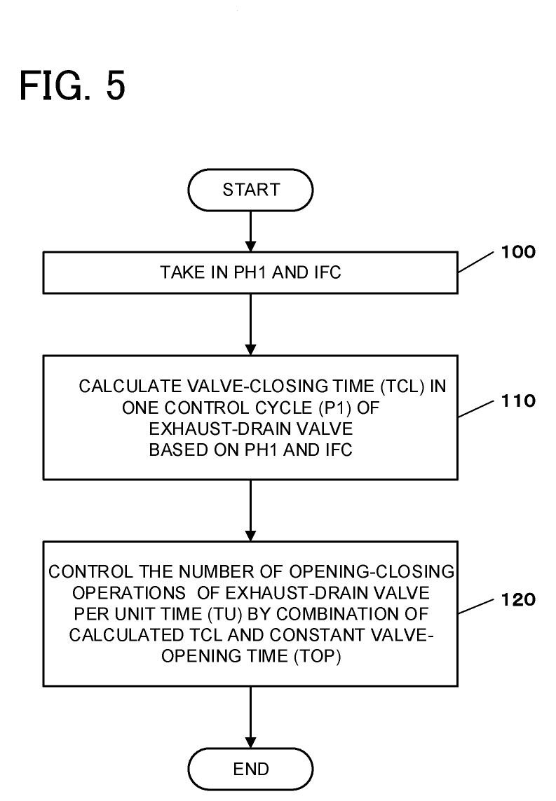

The “hydrogen off-gas circulation amount control” executed by the controller 20 will be described below. FIG. 5 is a flowchart showing one example of contents of this control. The control program related to this flowchart is stored in the memory unit of the controller 20. In the present embodiment, the controller 20 executes this hydrogen off-gas circulation amount control when performing the “uncontrolled power generation” according to the battery voltage and when performing the “low-current power generation” to intermittently stop power generation of the FC stack 11.

When the processing enters this routine shown in FIG. 5, the controller 20 takes in the inlet gas pressure PH1 of the injector 53 and the FC current IFC in step 100. Specifically, the inlet gas pressure PH1 is obtained from a measured value of the pressure sensor 16, and the FC current IFC is obtained from a measured value of the ammeter 17.

In step 110, the controller 20 then calculates a closing time TCL of the exhaust-drain valve 57 in one control cycle P1 based on the obtained inlet gas pressure PH1 and FC current IFC.

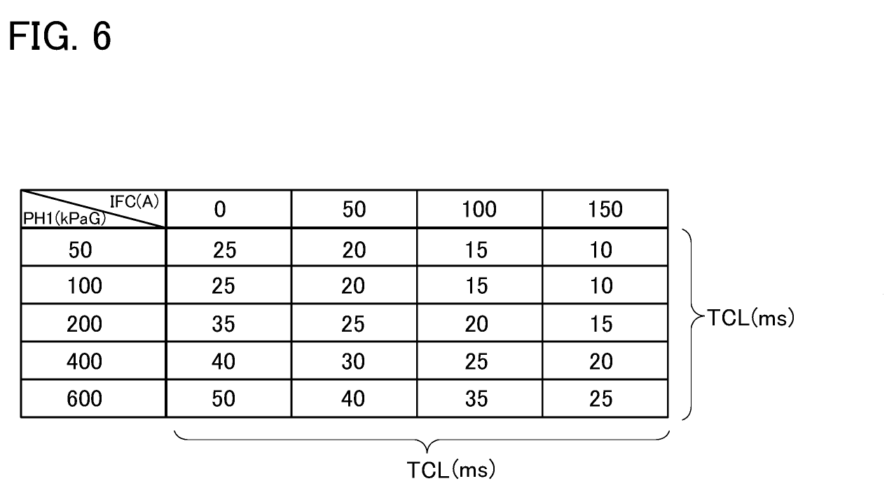

For example, the controller 20 can obtain the closing time TCL by referring to a closing time map shown in FIG. 6. This closing time map sets the relationship of the closing time TCL to the inlet gas pressure PH1 and the FC current IFC. The map in FIG. 6 is set such that as the inlet gas pressure PH1 is higher in the range of 50 to 600 (kPaG), the closing time TCL is longer in the range of 10 to 50 (ms). Furthermore, the map is set such that as the FC current IFC is greater in the range of 0 to 150 (A), the closing time TCL is shorter in the range of 25 to 10 (ms). In the present embodiment, the closing time TCL per one control cycle P1 in the duty control is controlled to control the number of opening-closing operations of the exhaust-drain valve 57 per unit time TU, and hence the total opening time per unit time.

In step 120, the controller 20 successively controls the number of opening-closing operations of the exhaust-drain valve 57 per unit time TU by combining the calculated closing time TCL and a constant opening time TOP (e.g., 200 ms). The controller 20 temporarily terminates subsequent processing.

According to the above-described control, the controller 20 controls the number of opening-closing operations of the exhaust-drain valve 57 according to the measured value of the pressure sensor 16 in order to adjust the circulation flow rate of hydrogen off-gas caused to recirculate to the hydrogen gas supply passage 31 via the hydrogen off-gas circulation passage 33. The controller 20 also controls the number of opening-closing operations of the exhaust-drain valve 57 based on the current measured value of the ammeter 17 in order to adjust the circulation flow rate of hydrogen off-gas, in addition to based on the pressure measured value of the pressure sensor 16.

According to the foregoing control, the controller 20 controls the closing time TCL of the exhaust-drain valve 57 per one control cycle P1 to be shorter as the current measured value of the ammeter 17 is higher. The controller 20 further controls the closing time TCL of the exhaust-drain valve 57 per one control cycle P1 to be longer as the pressure measured value of the pressure sensor 16 is higher.

### OPERATIONS AND EFFECTS OF FUEL CELL SYSTEM

According to the configuration of the fuel cell system 1 in the embodiment described above, the controller 20 controls the time ratio between the opening time TOP and the closing time TCL of the exhaust-drain valve 57 per one control cycle P1, and controls the number of opening-closing operations of the exhaust-drain valve 57 per unit time TU by keeping the opening time TOP constant and controlling the closing time TCL variably. Keeping the opening time TOP constant is to suppress the exhaust-drain valve 57 from opening for an excessive long period of time. Here, the longer the closing time TCL, the fewer the number of opening-closing operations of the exhaust-drain valve 57 per unit time TU, so that the total opening time of the exhaust-drain valve 57 per unit time TU is short. This reduces the circulation flow rate of hydrogen off-gas circulating to the hydrogen gas supply passage 31 via the hydrogen off-gas circulation passage 33. In contrast, the shorter the closing time TCL, the greater the number of opening-closing operations per unit time TU, so that the total opening time of the exhaust-drain valve 57 per unit time TU is long. This allows gases (nitrogen, water, etc.) produced by power generation of the FC stack 11 to be frequently discharged, thereby increasing the concentration of hydrogen gas in the hydrogen off-gas circulating to the hydrogen gas supply passage 31 via the hydrogen off-gas circulation passage 33. Furthermore, the controller 20 controls the number of opening-closing operations of the exhaust-drain valve 57 according to the inlet gas pressure PH1 (the pressure measured value) of hydrogen gas upstream of the ejector 54. Accordingly, the number of opening-closing operations is adjusted in accordance with the concentration of hydrogen gas, thereby adjusting the concentration of hydrogen gas in the hydrogen off-gas to be mixed with hydrogen gas in the ejector 54. Therefore, even if the pressure of hydrogen gas supplied to the ejector 54 is low, it is possible to adjust the concentration of hydrogen gas to be supplied from the ejector 54 to the FC stack 11, and thus suppress degradation of the power generation performance of the FC stack 11.

According to the configuration of the embodiment, the controller 20 controls the number of opening-closing operations of the exhaust-drain valve 57 based on the FC current IFC (the current measured value), which is the output current of the FC stack 11, in addition to based on the inlet gas pressure PH1 (the pressure measured value). Therefore, the number of opening-closing operations of the exhaust-drain valve 57 is adjusted according the generation status of gas (nitrogen, water, etc.) generated by power generation of the FC stack 11, thereby adjusting the concentration of hydrogen gas in the hydrogen off-gas to be mixed with hydrogen gas in the ejector 54. Accordingly, even if the flow velocity of hydrogen gas supplied to the ejector 54 decreases, it is possible to adjust the concentration of hydrogen gas to be supplied from the ejector 54 to the FC stack 11, thereby suppressing degradation of the power generation performance of the FC stack 11.

According to the configuration of the embodiment, as the FC current IFC is higher, the closing time of the exhaust-drain valve 57 per one control cycle P1 is made shorter, increasing the number of opening-closing operations of the exhaust-drain valve 57, so that the total opening time of the exhaust-drain valve 57 is lengthened. Therefore, when the output current of the FC stack 11 becomes high, the amount of gas (nitrogen, water, etc.) generated by the power generation in the FC stack 11 increases, and the concentration of hydrogen gas in the hydrogen off-gas discharged to the exhaust-drain passage 32 decreases. However, when the number of operations of the exhaust-drain valve 57 is increased, the gas generated during power generation of the FC stack 11 is frequently exhausted, thus suppressing a decrease in the concentration of hydrogen gas. This can increase the concentration of hydrogen gas to be supplied from the ejector 54 to the FC stack 11, thereby suppressing degradation of the power generation performance of the FC stack 11.

According to the configuration of the embodiment, when the inlet gas pressure PH1 of hydrogen gas becomes high, the controller 20 controls the closing time TCL of the exhaust-drain valve 57 per one control cycle P1 to be longer. This results in the reduced number of opening-closing operations of the exhaust-drain valve 57, shortening the total opening time of the exhaust-drain valve 57. In this case, the pressure of hydrogen gas supplied to the ejector 54 is high and a sufficient concentration of hydrogen gas is present in the hydrogen off-gas, and thus it is preferable to reduce the number of opening-closing operations of the exhaust-drain valve 57. In contrast, when the inlet gas pressure PH1 of hydrogen gas becomes low, the controller 20 controls the closing time TCL of the exhaust-drain valve 57 per one control cycle P1 to be shorter. This results in the increased number of opening-closing operations of the exhaust-drain valve 57, increasing the total opening time of the exhaust-drain valve 57. In this case, the pressure of hydrogen gas supplied to the ejector 54 is low and the gas (nitrogen, water, etc.) generated by power generation of the FC stack 11 is exhausted at a high concentration, and therefore the concentration of the hydrogen gas contained in the hydrogen off-gas is insufficient. Thus, the number of opening-closing operations of the exhaust-drain valve 57 is increased to raise the concentration of hydrogen gas contained in the hydrogen off-gas. As explained above, the controller 20 can control the number of operations of the exhaust-drain valve 57 in accordance with various concentrations of hydrogen gas in hydrogen off-gas, and suppress degradation of the power generation performance of the FC stack 11.

According to the configuration of the embodiment, the air system 22 includes the air compressor 71, air is directly supplied from the air compressor 71 to the FC stack 11, and air off-gas is directly discharged out of the FC stack 11. Therefore, no air valves or the like, other than the air compressor 71, are provided on the supply side of the air system 22, and also no air valves or the like are provided on the discharge side of the air system 22. This can simplify the air system 22 and reduce costs of the fuel cell system 1.

### OTHER EMBODIMENTS

The disclosure is not limited to the foregoing embodiments and may be embodied in other specific forms without departing from the essential characteristics thereof.

(1) In the above embodiment, the controller 20 uses both the pressure measured values of the pressure sensor 16 and the current measured values of the ammeter 17 to control the exhaust-drain valve 57, but may use only the pressure measured values of the pressure sensor 16.

(2) In the above embodiment, as the fuel gas supply unit, the hydrogen alloy canister 41 is provided, but alternatively a hydrogen tank filled with hydrogen may also be provided.

(3) In the above embodiment, the fuel cell system 1 is provided in an electric vehicle. As another application example, the fuel cell system of the disclosure may also be provided in vehicles other than electric vehicles.

(4) In the above embodiment, air valves and others are not provided on the supply side and the discharge side of the air system 22, but they may be provided.

(5) In the above embodiment, the fuel cell system 1 is configured as a closed cathode system in which the cooling system 23 and the air system 22 are separately provided. As an alternative, the fuel cell system of the disclosure can also be configured as an open cathode system in which an air system also functions as a cooling system.

The disclosure can be utilized for a fuel cell system mounted in, for example, an electric vehicle.

### Reference Signs List

1 Fuel cell system

11 FC stack (Fuel cell)

16 Pressure sensor

17 Ammeter

20 Controller

31 Hydrogen gas supply passage (Fuel gas supply passage)

32 Exhaust-drain passage (Fuel off-gas exhaust passage)

33 Hydrogen off-gas circulation passage (Fuel off-gas circulation passage)

41 Hydrogen alloy canister (Fuel gas supply unit)

53 Injector (Fuel gas supply unit)

54 Ejector

57 Exhaust-drain valve

What is claimed is:

1. A fuel cell system provided with a fuel cell that generates electric power by receiving supply of fuel gas and oxidant gas, the fuel cell system comprising:
a fuel gas supply passage for supplying the fuel gas to the fuel cell;
a fuel off-gas exhaust passage for exhausting fuel off-gas discharged from the fuel cell to an outside of the fuel cell system;
a fuel off-gas circulation passage for circulating at least a part of the fuel off-gas from the fuel off-gas exhaust passage to the fuel gas supply passage;
a fuel gas supply unit placed in the fuel gas supply passage and configured to supply the fuel gas;
an ejector placed downstream of the fuel gas supply unit in the fuel gas supply passage and configured to discharge a mixture of the fuel gas supplied from the fuel gas supply unit and the fuel off-gas circulating through the fuel off-gas circulation passage;
an exhaust-drain valve placed in the fuel off-gas exhaust passage and configured to exhaust the fuel off-gas to the outside;
a pressure sensor placed in the fuel gas supply passage and used to measure a pressure of the fuel gas upstream of the ejector; and
a controller configured to control the exhaust-drain valve,
wherein the controller variably controls a time ratio between an opening time and a closing time of the exhaust-drain valve per one control cycle, and controls the number of opening-closing operations of the exhaust-drain valve per unit time by keeping the opening time constant and controlling the closing time variably, and
the controller controls the number of opening-closing operations of the exhaust-drain valve according to a pressure measured value of the pressure sensor in order to adjust a concentration of the fuel gas in the fuel off-gas caused to circulate to the fuel gas supply passage via the fuel off-gas circulation passage.

2. The fuel cell system according to claim 1, further comprising an ammeter for measuring an output current of the fuel cell,
wherein the controller controls the number of opening-closing operations of the exhaust-drain valve according to a current measured value of the ammeter in addition to the pressure measured value in order to adjust the concentration of the fuel gas in the fuel off-gas.

3. The fuel cell system according to claim 2, wherein the controller controls the closing time of the exhaust-drain valve per the one control cycle to be shorter as the current measured value is higher.

4. The fuel cell system according to claim 1, wherein the controller controls the closing time of the exhaust-drain valve per the one control cycle to be longer as the pressure measured value is higher.

5. The fuel cell system according to claim 2, wherein the controller controls the closing time of the exhaust-drain valve per the one control cycle to be longer as the pressure measured value is higher.

6. The fuel cell system according to claim 3, wherein the controller controls the closing time of the exhaust-drain valve per the one control cycle to be longer as the pressure measured value is higher.
